(19) United States
(12) Patent Application Publication
(10) Pub. No.: US 2016/0084461 A1
(43) Pub. Date: Mar. 24, 2016

(54) VEHICLE LAMP

(71) Applicant: Hitachi Maxell, Ltd., Osaka (JP)

(72) Inventors: Hiroyuki NAKAMURA, Ibaraki (JP); Kei ADACHI, Ibaraki (JP)

(73) Assignee: Hitachi Maxell, Ltd., Osaka (JP)

(21) Appl. No.: 14/786,924

(22) PCT Filed: Apr. 26, 2013
(86) PCT No.: PCT/JP2013/062316

§ 371 Date: Oct. 23, 2015

(51) Int. Cl. F21S 8/10

(52) U.S. Cl. CPC F21S 48/1225; F21S 48/1208; F21S 48/13; F21Y 2101/025

(57) ABSTRACT

Provided is a vehicle lamp for emitting illumination light having reduced color nonuniformity and luminance variation with a simple structure. The vehicle lamp comprises: a light source for emitting excitation light; a fluorescent body for emitting fluorescent light excited by the excitation light emitted from the light source; a diffuser for diffusing the excitation light specularly reflected on the surface of the fluorescent body; and a reflector for reflecting the fluorescent light emitted from the fluorescent body and the excitation light diffused by the diffuser ahead of a vehicle. The fluorescent body is arranged above the light source, and the reflection surface of the reflector is arranged to face the fluorescent body from the direction in which the light is specularly reflected on the fluorescent body toward the lower side of the fluorescent body.

### TECHNICAL FIELD

The present invention relates to a vehicle lamp using a laser light-emitting element.

### BACKGROUND

As vehicle lamps such as vehicle headlamps in recent years, for decreasing energy consumed by a light source, products using a light-emitting diode (LED) and a laser diode (LD) have been proposed and some of them have already been put into practice. An LD light source, in particular, has high photoelectric conversion efficiency and a small light-emission area, and, therefore, is advantageous for downsizing the lamp.

For the vehicle lamp, chromaticity is prescribed in international standards or the like, such that the headlamp is predetermined to be white or pale yellow. Furthermore, there has been a high demand, in recent years, for higher color temperature in illumination light the headlamp emits. Patent Literature 1 discloses a lighting device including an excitation light source that emits blue band excitation light (laser beam), a light emitting portion that receives the excitation light and emits fluorescent light ranging from a green band to a red band, and a light mixing layer that mixes the excitation light with the fluorescent light.

### CITATION LIST

### Patent Literature

PATENT LITERATURE 1: JP-A-2012-54084

### SUMMARY OF INVENTION

### Technical Problem

Patent Literature 1 discloses a configuration for reducing the color unevenness and luminance unevenness, in which a reflector has a transmission hole to transmit the excitation light, and excitation light is irradiated to the phosphor via the transmission hole. There is a problem, however, that it is difficult to machine the transmission hole appropriately. The transmission hole, if it is too large, may increase leakage of illumination light, and if it is too small, may have difficulty in adjusting transmission of the excitation light.

An object of the present invention is to provide a vehicle lamp in that has reduced color unevenness and luminance unevenness with a simple structure.

### Solution To Problem

To solve the above problem, one appropriate embodiment of the present invention is as follows. The vehicle lamp includes a light source that emits excitation light, a phosphor that is excited with the excitation light emitted from the light source and emits fluorescent light, a diffusion plate configured to diffuse specular reflection light specularly reflected on a surface of the phosphor, among the excitation light, a reflector configured to reflect the fluorescent light emitted from the phosphor, and diffused excitation light diffused from the diffusion plate, toward a vehicle front side. In this configuration, the phosphor is disposed on the upper side of the light source. A reflection surface of the reflector is arranged so as to face the phosphor across a range from a direction of the specular reflection light reflected from the phosphor toward a lower side of the phosphor.

Advantageous Effects Of Invention

According to the present invention, it is possible to provide a vehicle lamp that has reduced color unevenness and luminance unevenness with a simple structure.

### BRIEF DESCRIPTION OF DRAWINGS

FIG. 1 is a side sectional view of a vehicle lamp configuration.

FIG. 2 is a side sectional view of an optical path of illumination light.

### DESCRIPTION OF EMBODIMENTS

### Embodiments

Hereinafter, embodiments of the present invention will be described with reference to the drawings.

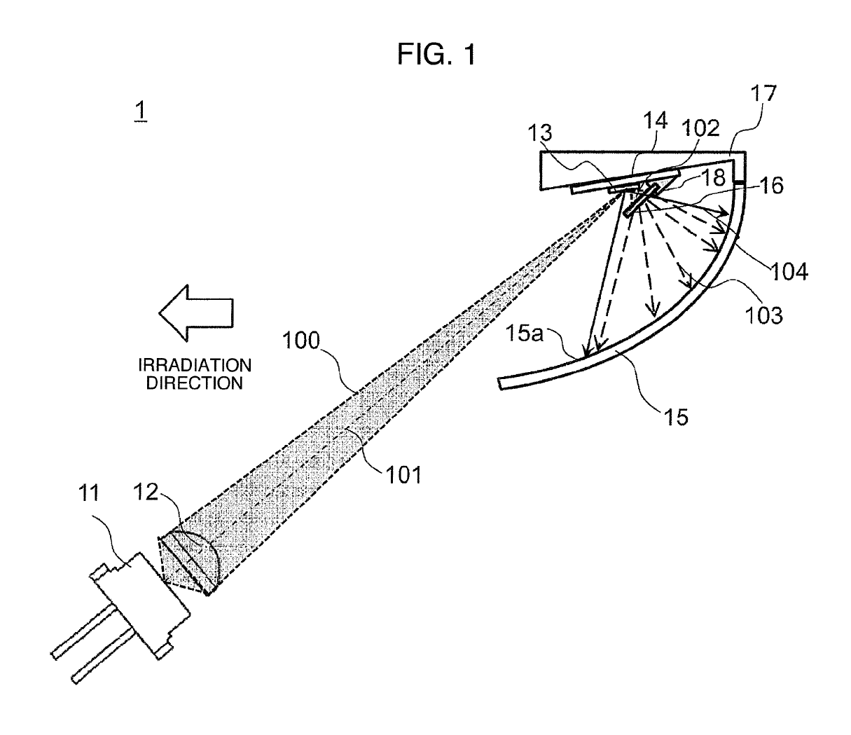

FIG. 1 is a side sectional view of a vehicle lamp configuration including an optical path of excitation light. The vehicle lamp 1 is a projector-type lamp and includes a light source 11 including a semiconductor light-emitting element, a condenser lens 12, a phosphor 13 that is excited with excitation light and emits yellow fluorescent light, a metal plate 14, a reflector 15, a diffusion plate 16, a metal plate holder 17, and a diffusion plate holder 18. The light source 11 is a laser diode (LD) and emits excitation light (blue laser beam). The condenser lens 12 is disposed on an emission side of the light source 11 and causes the excitation light emitted from the light source 11 to be focused on a surface of the phosphor 13 disposed on the upper side. The phosphor 13 is provided in an area on the metal plate 14. The metal plate 14 is fixed to the reflector 15 via the metal plate holder 17.

Most of the excitation light 100 incident on the phosphor 13 is converted into fluorescent light 104 that has no directivity (incoherent), and then is scattered, Part of the excitation light, however, is not converted into the fluorescent light and is specularly reflected as excitation light on a surface of the phosphor. Specular reflection light 102, which is a component of the specularly reflected excitation light, is transmitted through the diffusion plate 16 to become diffused excitation light 103 having no directivity. The diffused excitation light (blue light) 103 is mixed with the fluorescent light (yellow light) 104 to become white light, and is incident on the reflector 15. In case of using the excitation light, the wavelength of which is 450 nm (blue), and the phosphor having a wavelength in a region ranging from 500 to 650 nm (green-yellow-red), approximately 30% of the excitation light 100 is specularly reflected on the phosphor 13 and becomes part of white light with high color temperature that meets headlamp standards.

The diffusion plate 16 is a transmission-type diffusion plate made of glass and fixed to the metal plate 14 via the diffusion plate holders 18. The diffusion plate 16 is arranged such that, after the excitation light 100 has been incident on the phosphor 13, the excitation light 100 may be parallel to an optical axis 101 of the excitation light 100 on an optical path formed by specular reflection of the excitation light 100. Parallel arrangement is adopted because this prevents the excitation light 100 from being blocked by the diffusion plate 16, and enables decreasing the distance between the phosphor 13 and the diffusion plate 16. The closer the light-emitting point of the diffusion plate 16 and the light-emitting point of the phosphor 13, the more similar illumination light distributions for each of the diffused excitation light and the fluorescent light. This leads to a reduction of color unevenness and luminance unevenness.

The metal plate 14 that holds the phosphor 13 has a mirror surface. The metal plate 14 is tilted with respect to the horizontal direction and arranged such that the specular reflection light 102 may be transmitted through the diffusion plate 16 to be guided in a direction toward the reflector 15. The specular reflection light 102 is a component specularly reflected on the surface of the phosphor 13 among the excitation light 100 emitted from the light source 11. Accordingly, the white light generated from the phosphor 13 is incident on the reflector 15.

The reflector 15 has a shape of curved plate that opens diagonally in a direction toward the upper front, and is disposed so as to face the lower side of the phosphor 13. The upper surface of the reflector 15 has a reflection surface 15a that reflects the white light emitted from the phosphor 13 toward the vehicle front side. The reflection surface 15a has a free curved surface shape such as a parabolic surface-based shape so as to obtain desired light distribution. The reflection surface 15a faces the phosphor 13 across a range from the rear of the phosphor 13 (direction of the reflected specular reflection light 102 from the phosphor 13) toward the lower side, and irradiates the white light emitted from the phosphor 13 toward the vehicle front side.

Using a free curved surface reflector has an advantage that it is possible to achieve downsizing of the headlamp and a complicated light distribution property such as in an adaptive driving beam (ADB). In recent years, there is an increasing demand for a headlamp with an ADB technique that allows a driver to visually recognize pedestrians more easily and that inhibits irradiating the opposing vehicle excessively. In conventional techniques, complicated light distribution such as the ADB is implemented by mounting a plurality of light sources. Using the free curved surface reflector, which uses less light sources, makes it possible to downsize the headlamp.

The excitation light 100 emitted from the light source 11 is condensed by the condenser lens 12, and is incident on a surface of the phosphor 13 diagonally from a lower front direction. Then, the specular reflection light 102 directed from the phosphor 13 in a direction toward a rear side is incident on the diffusion plate 16 to be diffused, Accordingly, the excitation light that has been specularly reflected on the surface of the phosphor is diffused, enabling emission to an entire area of illumination light. Therefore, it is possible to mix the excitation light with the fluorescent light evenly and to provide illumination light with reduced color unevenness and luminance unevenness.

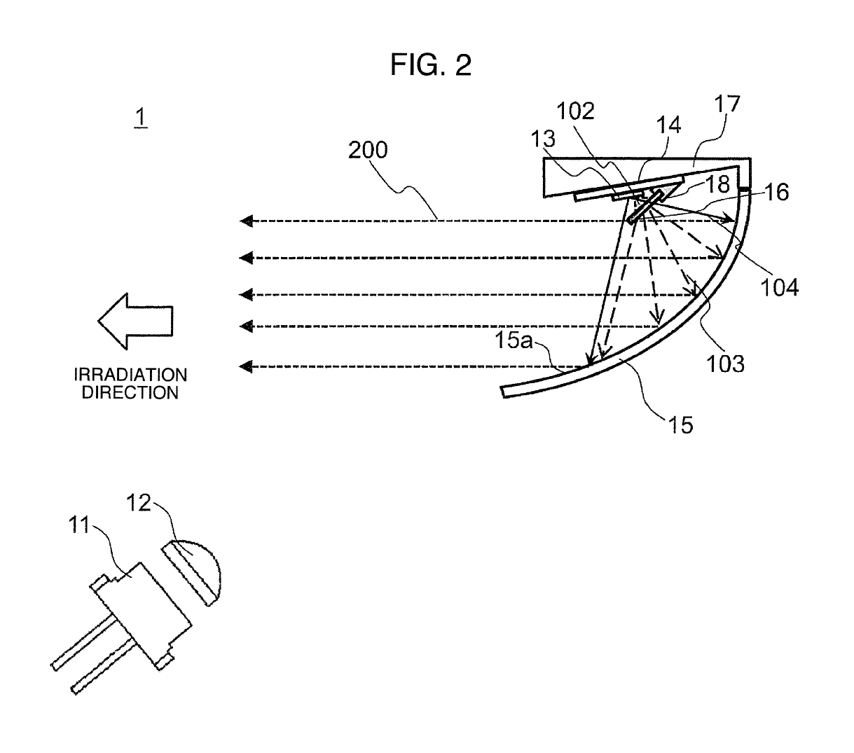

FIG. 2 is a side sectional view of the optical path of the illumination light of the vehicle lamp 1. As described above, the diffused excitation light 103 is mixed with the fluorescent light 104 to become white illumination light, and is directed to the lower side. The illumination light 200 is reflected on the reflection surface 15a of the reflector 15 forwardly and emitted toward the vehicle front side. Since the reflection surface 15a has a free curved shape, the irradiation light 200 is emitted so as to obtain desired light distribution.

As described above, the vehicle lamp 1 according to the present embodiment can be a vehicle lamp that emits illumination light in which color unevenness and luminance unevenness have been reduced with a simple configuration.

### REFERENCE SIGNS LIST

1: vehicle lamp, 11: light source, 12: condenser lens, 13: phosphor, 14: metal plate, 15: reflector, 15a: reflection surface, 16: diffusion plate, 17: metal plate holder, 18: diffusion plate holder, 100: excitation light, 101: optical axis of excitation light, 102; specular reflection light of excitation light, 103: diffused excitation light, 104: fluorescent light, 200: illumination light

1. A vehicle lamp comprising:
a light source that emits excitation light;
a phosphor that is excited with the excitation light emitted from the light source and emits fluorescent light;
a diffusion plate configured to diffuse specular reflection light specularly reflected on a surface of the phosphor, among the excitation light; and
a reflector configured to reflect the fluorescent light emitted from the phosphor and diffused excitation light diffused from the diffusion plate toward a vehicle front side,
wherein the phosphor is disposed on an upper side of the light source, and
a reflection surface of the reflector is disposed so as to face the phosphor across a range from a direction of the specular reflection light reflected from the phosphor toward a lower side of the phosphor.

2. The vehicle lamp according to claim 1, further comprising:
a metal plate for forming the phosphor in a partial region;
a metal plate holder for fixing the metal plate with respect to the reflector; and
a diffusion plate holder for fixing the diffusion plate with respect to the metal plate.

3. The vehicle lamp according to claim 2, wherein the diffusion plate holder fixes the diffusion plate in parallel with an optical axis of the excitation light to be incident on the phosphor.

4. A vehicle lamp comprising:
a semiconductor light-emitting element that emits excitation light;
a phosphor that is excited with the excitation light emitted from the semiconductor light-emitting element and emits fluorescent light;
a diffusion plate configured to diffuse excitation light specularly reflected on a surface of the phosphor, among the excitation light, and
a reflector configured to reflect the fluorescent light emitted from the phosphor and diffused excitation light diffused from the diffusion plate toward a vehicle front side,
wherein the diffusion plate is arranged in parallel with an optical axis of the excitation light to be incident on the phosphor.

5. The vehicle lamp according to claim 1 wherein the fluorescent light is mixed with the diffused excitation light and becomes substantially white light and is emitted as illumination light toward the vehicle front side.

6. The vehicle lamp according to any one of claim 2, wherein the fluorescent light is mixed with the diffused excitation light and becomes substantially white light and is emitted as illumination light toward the vehicle front side.

7. The vehicle lamp according to any one of claim 3, wherein the fluorescent light is mixed with the diffused excitation light and becomes substantially white light and is emitted as illumination light toward the vehicle front side.

8. The vehicle lamp according to any one of claim 4, wherein the fluorescent light is mixed with the diffused excitation light and becomes substantially white light and is emitted as illumination light toward the vehicle front side.
